(19) United States
(12) Patent Application Publication
(10) Pub. No.: US 2015/0280187 A1
(43) Pub. Date: Oct. 1, 2015

(54) BATTERY COMPARTMENTS WITH SERVICE PLATFORMS

(71) Applicant: Deere & Company, Moline, IL (US)

(72) Inventors: Sebastian Yaklin, Dubuque, IA (US); Brandon Kuboushek, Dubuque, IA (US); Steven T. Blasen, Peosta, IA (US); Charles Edward Clift, Dubuque, IA (US); Charles Christopher Krampert, Huntsville, AL (US)

(73) Assignee: Deere & Company, Moline, IL (US)

(21) Appl. No.: 14/231,214

(22) Filed: Mar. 31, 2014

(51) Int. Cl. H01M 2/10

(52) U.S. Cl. CPC H01M 2/1083

(57) ABSTRACT

Battery compartments with service platforms are disclosed. An example battery compartment apparatus includes a housing to store at least one battery of a working machine. A cover is removably attached to the housing and the cover is positionable between an operable position and a service position. A tray to hold the at least one battery is disposed on a base of the housing. The cover at least partially supports the tray in the service position.

### FIELD OF THE INVENTION

The present disclosure pertains to battery compartments and, more particularly, to battery compartments with service platforms.

### BACKGROUND OF THE INVENTION

Batteries for working machines, such as log skidders, feller bunchers, loaders, tractors and the like are typically stored near the engine compartment. Typically, working machines have two or more batteries that can each weigh sixty pounds or more. Such batteries are often difficult to access and/or remove for service and/or maintenance. The size and weight of each battery make it difficult to grasp and/or lift the batteries from their storage compartments.

### SUMMARY

An example apparatus includes a housing to store at least one battery of a working machine. A cover is removably attached to the housing and the cover is positionable between an operable position and a service position. A tray to hold the at least one battery is disposed on a base of the housing. The cover at least partially supports the tray in the service position.

Another example apparatus includes a battery housing of a working machine defining a cavity for storing at least one battery. A cover is removably attached to the battery housing and is configurable between an operable position and a service position. The cover includes first and second brackets fixably attached to the cover and first and second hooks extending from each of the first and second brackets. The first and second hooks engage respective mounting features of the battery housing to support the cover in the service position.

### BRIEF DESCRIPTION OF THE DRAWINGS

FIG. 1 is a side elevational view of an example working machine.

FIG. 2 is a perspective view of an example battery storage apparatus that may be incorporated into the working machine of FIG. 1.

FIG. 3 is a perspective view of the example battery storage apparatus of FIG. 2 with first and second covers detached from a step portion to expose an opening of the step portion.

FIG. 4 illustrates the example battery storage apparatus of FIG. 2 and FIG. 3 with the batteries depicted using phantom lines.

FIG. 5 illustrates the example battery storage apparatus of FIGS. 2-4 with the first cover configured in the service position.

FIG. 6A illustrates a first bracket of the first cover and a mounting tab of a first mounting feature of the step portion.

FIG. 6B illustrates the first bracket of the first cover as depicted in FIG. 6A partially engaged with the mounting tab of the step portion to mount the first cover in a service position.

FIG. 6C illustrates the first bracket of the first cover of FIGS. 6A and 6B engaged with the mounting tab of the step portion such that the first cover is mounted in the service position.

FIG. 7 illustrates the example battery storage apparatus of FIGS. 2-5 with the batteries prepared to be moved to the service position.

FIG. 8 illustrates the example battery storage apparatus of FIGS. 2-5 and 7 with the batteries disposed in the service position.

### DETAILED DESCRIPTION

Battery compartments for working machines are disclosed herein. Example battery compartments provide superior accessibility for service and/or maintenance of batteries compared to known battery compartments.

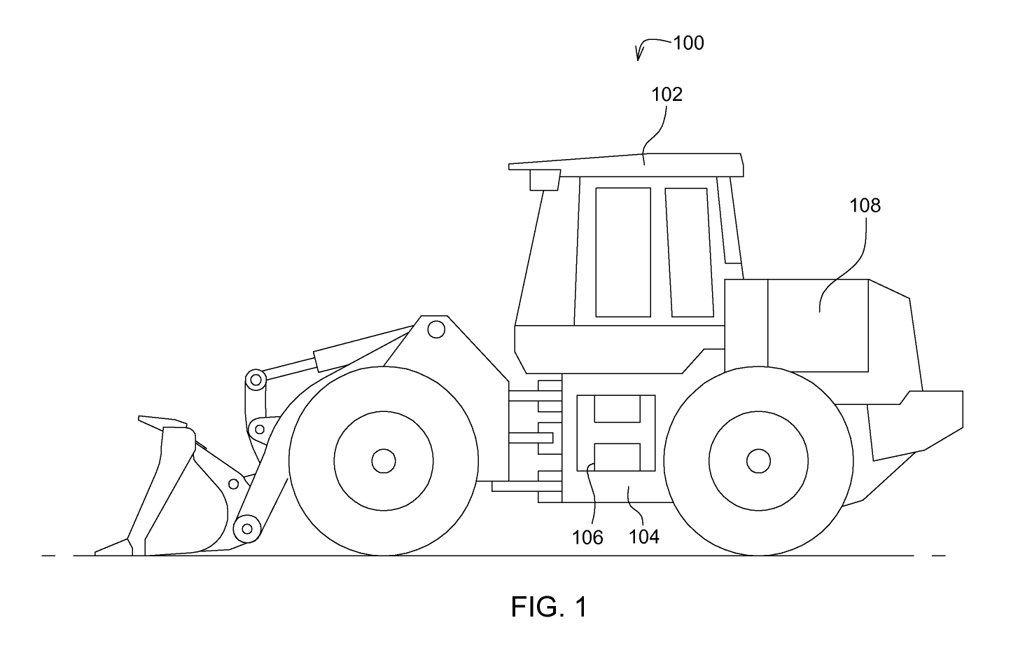

FIG. 1 illustrates an example working machine 100. The working machine has a cab 102 attached to a frame 104. Steps 106 are attached to the frame 104 to provide operator access to the cab 102. The working machine 100 includes one or more batteries (not shown) to provide power to various components (e.g., a starter motor, lights, electronic controls, etc.). The batteries are typically stored near an engine compartment 108 or at other locations near the generator, starter motor and control modules, to minimize battery cable length and, therefore, voltage drop. However, there are numerous disadvantages to storing batteries near the engine compartment and in other positions on the working machine, those disadvantages include accessibility, protection from damage, and storage environment, among others.

Batteries on working machines are often difficult to access and/or remove for service and maintenance. For example, batteries are often stored in close proximity to other components. Thus, accessing and/or removing batteries is often difficult. Such batteries can each weigh sixty pounds or more, so it is desirable for an operator to be able to securely grip the batteries while positioned in a comfortable lifting position to facilitate removal thereof. Crowded and/or inconveniently located storage spaces make battery access and/or removal difficult. For example, if an operator must climb onto a frame member to remove the batteries, it can be difficult to remove the batteries from their storage compartment and subsequently carry the batteries off of the working machine.

In addition, batteries must be protected from damage due to, for example, punctures from tree limbs and/or other objects. Thus, it is important to store batteries in compartments that are shielded by protective members. Accordingly, batteries are often stored in locations internal to the frame, which again poses access difficulties. Furthermore, batteries should not be exposed to excessive heat, such as heat from an engine. Excessive heat exposure can degrade battery performance and life.

The battery compartments described herein provide convenient access to batteries of working machines. The example battery compartments include a cover that is positionable between an operable position and a service position. The batteries are slidable onto the cover in the service position, such that the batteries may be conveniently accessed and/or removed. In addition, example battery compartments are disposed at locations on the working machine that are isolated from substantial engine heat and that are shielded from damage due to punctures from external objects. Additionally or alternatively, the batteries and/or battery compartment may be located at a level above a water fording line (e.g., a centerline of the engine crankshaft) to allow effective operation in water up to such a level and/or facilitate service access.

The examples described herein include a housing to store batteries of a working machine. The housing includes a cover removably attached to the housing and positionable between an operable position and a service position. The batteries are disposed on a tray within the housing and are secured in the operable position by a retainer. The cover defines a service platform to receive the batteries in the service position. The retainer provides a handle for a user to pull the batteries, via the tray, onto the service platform.

For purposes of clarity and brevity, the examples described herein are described with respect to working machines including two batteries. However, other examples in accordance with the present disclosure can be utilized with working machines that include one battery or more than two (e.g., four) batteries. In addition, the examples are described herein with respect to a loader (e.g., a wheel loader. However, the examples described herein can be utilized by various types of working machines including but not limited to skidders, feller bunchers, forwarders, harvesters, dozers (e.g., crawler dozers and high-speed dozers), loaders (e.g., backhoe loaders, track loaders, crawler loaders, tractor loaders, wheel loaders, knuckleboom loaders, etc.), forestry swing machines, dump trucks, excavators, graders, scrapers, waste equipment, tractors, and the like.

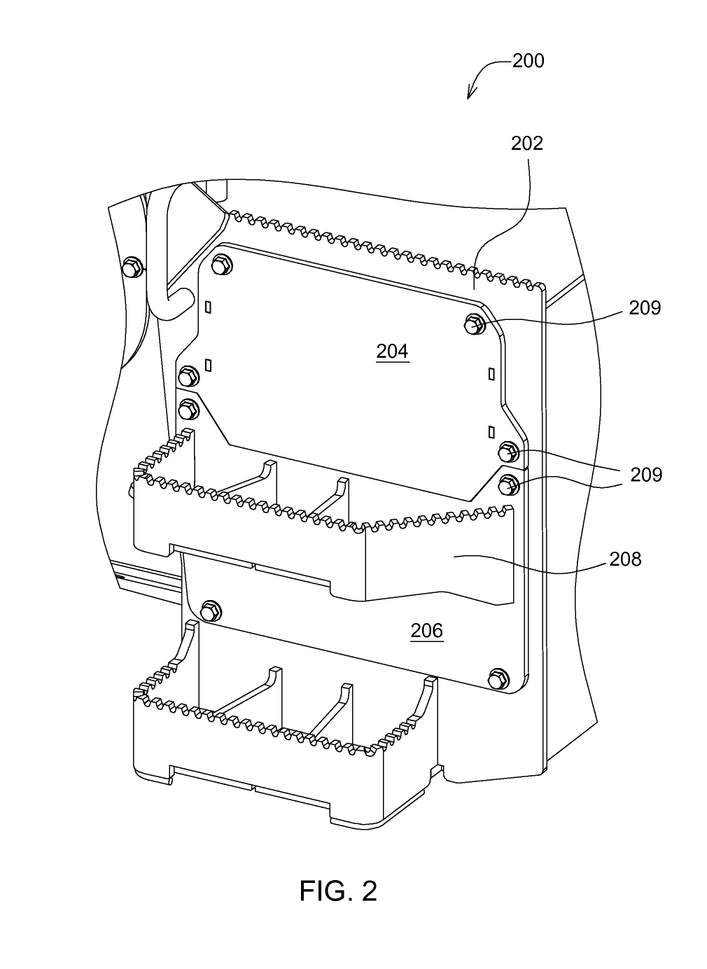

Turning to FIG. 2, an example battery storage apparatus 200 is illustrated. The example battery storage apparatus 200 is disposed within a step portion 202 (e.g., the steps 106 of FIG. 1) of a working machine (e.g., the working machine 100 of FIG. 1). However, in other examples, the battery storage apparatus 200 is located in other locations on the working machine, such as within other portions of the frame (e.g., the frame 104 of FIG. 1).

The battery storage apparatus 200 includes a first cover 204 and a second cover 206 disposed below the first cover 204. The second cover 206 includes a step member 208. The first and second covers are 204, 206 are removably coupled to the step portion 202 via fasteners 209 (e.g., bolts). The first and second covers 204, 206 cover an opening (not shown) in the step portion 202. The first cover 204 is positionable between an operable position and a service position. FIG. 2 illustrates the first cover 204 in the operable position. The first cover 204 and the batteries (not shown) are to be positioned in the operable position to operate the working machine, and to be positioned in the service position to service and/or remove the batteries.

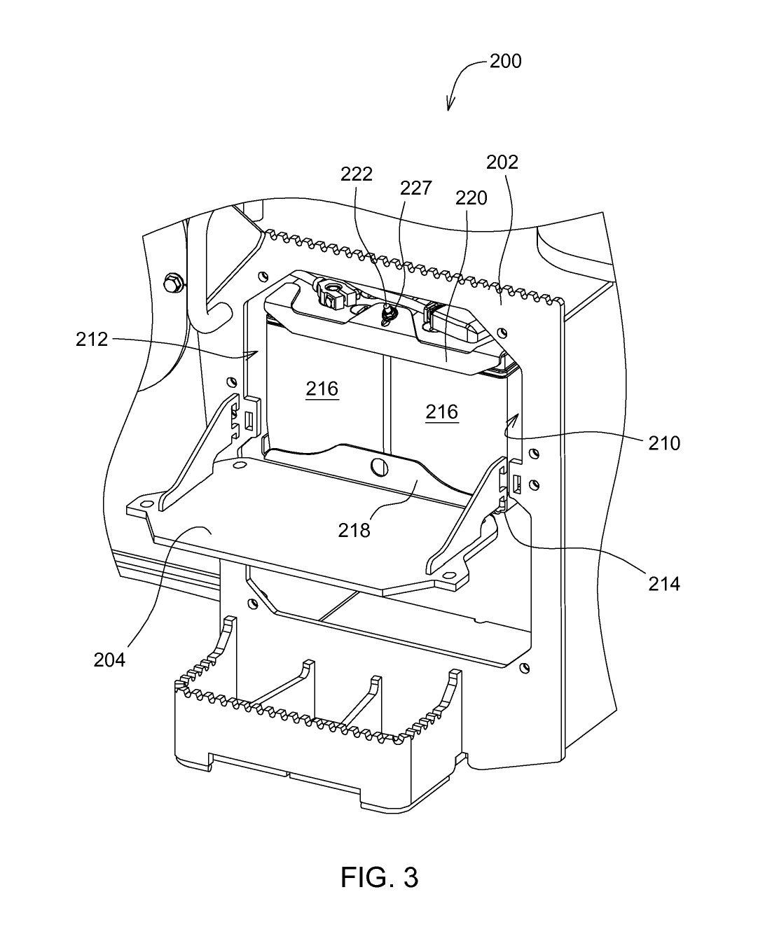

Turning to FIG. 3, the example battery storage apparatus 200 of FIG. 2 is illustrated with the first and second covers 204, 206 detached from the step portion 202 to expose an opening 210 of the step portion 202. A battery housing 212 is disposed within the opening 210 and is defined by, inter alia, the first cover 204 and a base 214. Batteries 216 are disposed on a tray 218, which is disposed on the base 214. The example battery storage apparatus 200 includes two batteries 216; however, other examples include one battery 216 or more than two batteries 216. The batteries 216 are secured within the battery housing 212 by a retainer 220 adjustably coupled to a rod 222 via a fastener 227. The retainer 220 and the rod 222 of the illustrated example secure two batteries.

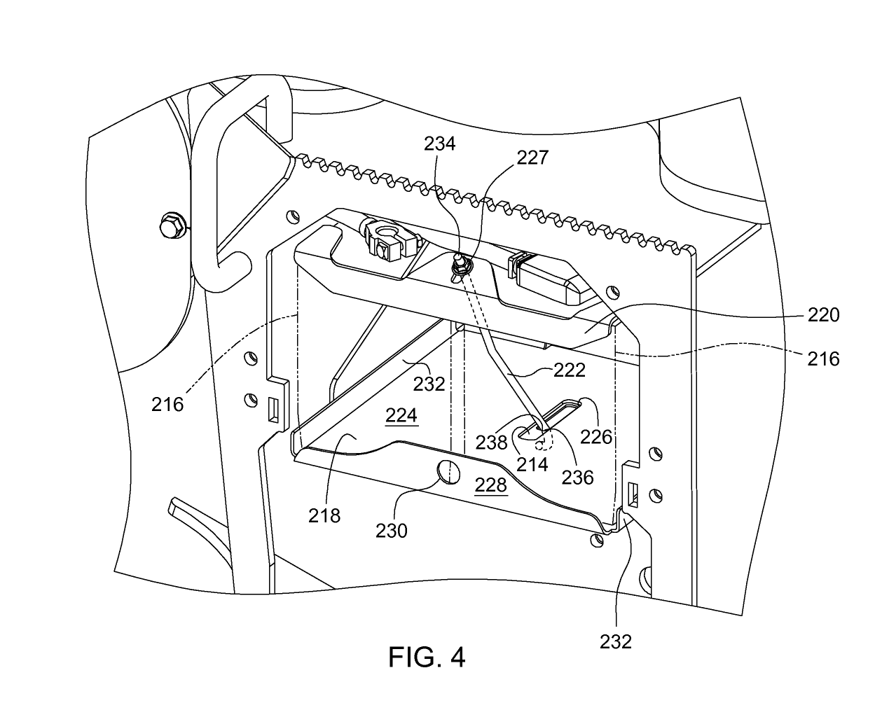

FIG. 4 illustrates the example battery storage apparatus 200 of FIGS. 2 and 3. For illustrative purposes, the batteries 216 are shown in phantom lines in FIG. 4. The tray 218 includes a base member 224 having a base aperture 226. The tray 218 also includes a first lip portion 228 having a lip aperture 230 and second lip portions 232. The first and second lip portions 228, 232 are formed at a periphery of the tray 218 to retain the batteries 216 in the tray 218. The base member 224 of the tray 218 of the example battery storage apparatus 200 is a unitary member having a single aperture, namely, the aperture 226. However, in other examples, the base member 224 of the tray 218 may include additional apertures and/or features. For example, the tray 218 may include additional apertures to reduce tray weight and/or additional features to position and/or retain the batteries.

As mentioned above, the batteries 216 are secured within the battery housing 212 by the retainer 220 adjustably coupled to the rod 222 via the fastener 227. The rod 222 is disposed between the batteries 216 and has a first end 234 and a second end 236 opposite the first end 234. The fastener 227 is coupled (e.g., threadably coupled) to the first end 234 of the rod 222. The second end 236 of the rod 222 engages a catch 238 in the base 214 of the battery housing 212 via the aperture 226 of the base member 224 of the tray 218. The fastener 227 is tightened to compressively retain the batteries 216 between the retainer 220 and the base 214 of the battery housing 212.

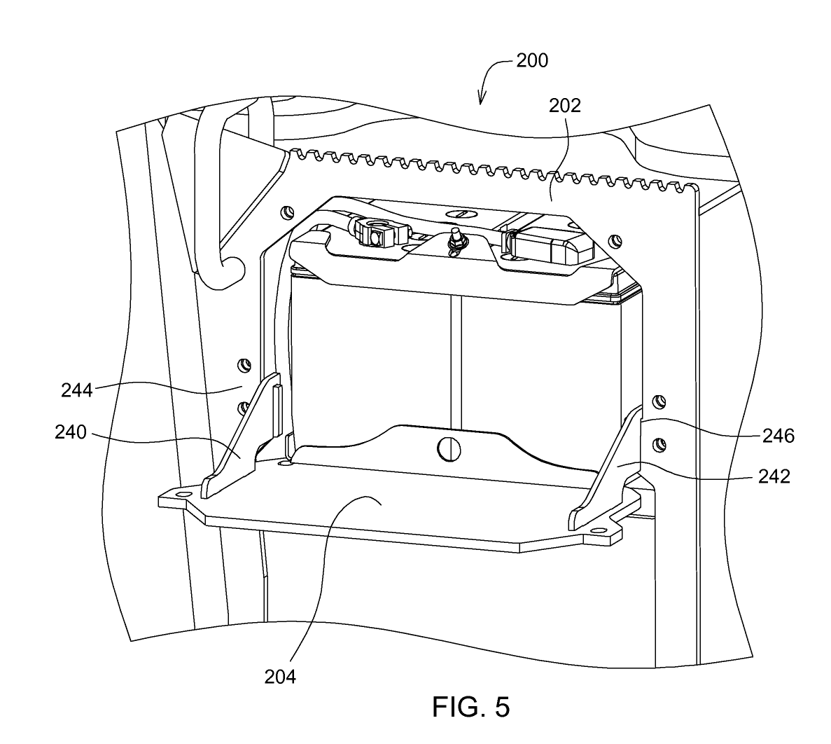

FIG. 5 illustrates the example battery storage apparatus 200 of FIGS. 2-4 with the first cover 204 configured in the service position. As mentioned above, the first cover 204 is positionable between an operable position (e.g., as illustrated in FIG. 2) and a service position (e.g., as illustrated in FIG. 5). First and second brackets 240, 242 are fixably attached (e.g., welded) to the first cover 204. The first and second brackets 240, 242 engage respective first and second mounting features 244, 246 to retain the first cover 204 on the step portion 202 in the service position.

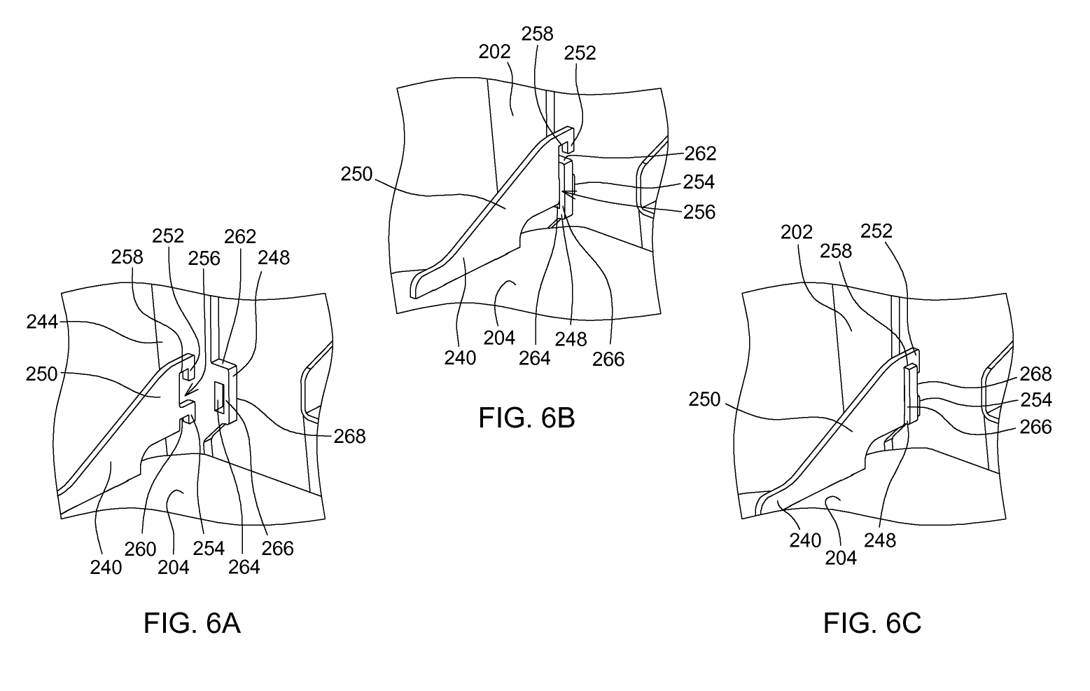

Turning to FIGS. 6A-6C, the mounting configuration for the first cover 204 in the service position is illustrated. FIG. 6A illustrates the first bracket 240 of the first cover 204 and a mounting tab 248 of the first mounting feature 244 of the step portion 202. The second bracket 242 may include features that are the same as or similar to those of the first bracket 240. The first bracket 240 includes an arm 250 that extends from the first cover 204. The arm 250 has first and second hooks 252, 254 extending from a distal face 256 of the arm 250. The first hook 252 defines a first pocket 258 between the first hook 252 and the distal face 256 of the arm 250. The second hook 254 defines a second pocket 260 between the second hook 254 and the distal face 256 of the arm 250. The mounting tab 248 defines a top surface 262 and an aperture 264. The mounting tab 248 has a thickness between an outer face 266 and an inner face 268. The thickness of the mounting tab 248 is slightly smaller than a width of the first and second pockets 258, 260. The mounting configuration of FIGS. 6A-6C is merely an example mounting configuration. Other examples may utilize any appropriate mounting features. For example, the mounting feature 244 of certain examples includes two apertures on the step portion 202 in lieu of the mounting tab 248 to be engaged by the first and second hooks 252, 254 to mount the first cover 204 in the service position.

FIG. 6B illustrates the first bracket 240 of the first cover 204 partially engaged with the mounting tab 248 of the step portion 202 to mount the first cover 204 in the service position. The first bracket 240 is positioned such that the distal face 256 of the arm 250 of the first bracket 240 abuts the outer face 266 of the mounting tab 248. The first hook 252 is positioned such that the first pocket 258 of the first hook 252 is disposed above the top surface 262 of the mounting tab 248 and the second hook 254 extends through the aperture 264 of the mounting tab 248.

FIG. 6C illustrates the first bracket 240 of the first cover 204 engaged with the mounting tab 248 of the step portion 202 such that the first cover 204 is mounted in the service position. Upon reaching the partially engaged position of FIG. 6B, the first cover 204 is slid downwardly to the fully engaged position of FIG. 6C such that the mounting tab 248 engages the first pocket 258 of the first hook 252 and the second pocket 260 of the second hook 254. As mentioned above, the mounting tab 248 has a thickness between its outer face 266 and its inner face 268 that is slightly smaller than the width of the first and second pockets 258, 260. Accordingly, the first cover 204 is held snugly against the step portion 202 in the service position via the first and second brackets 240, 242 and the mounting tab 248. By utilizing two hooks per bracket (e.g., the first and second hooks 252, 254 of the first bracket 240), the first cover 204, when mounted in the service position, is sufficiently strong and robust to support the heavy batteries 216, each of which can weigh sixty pounds or more.

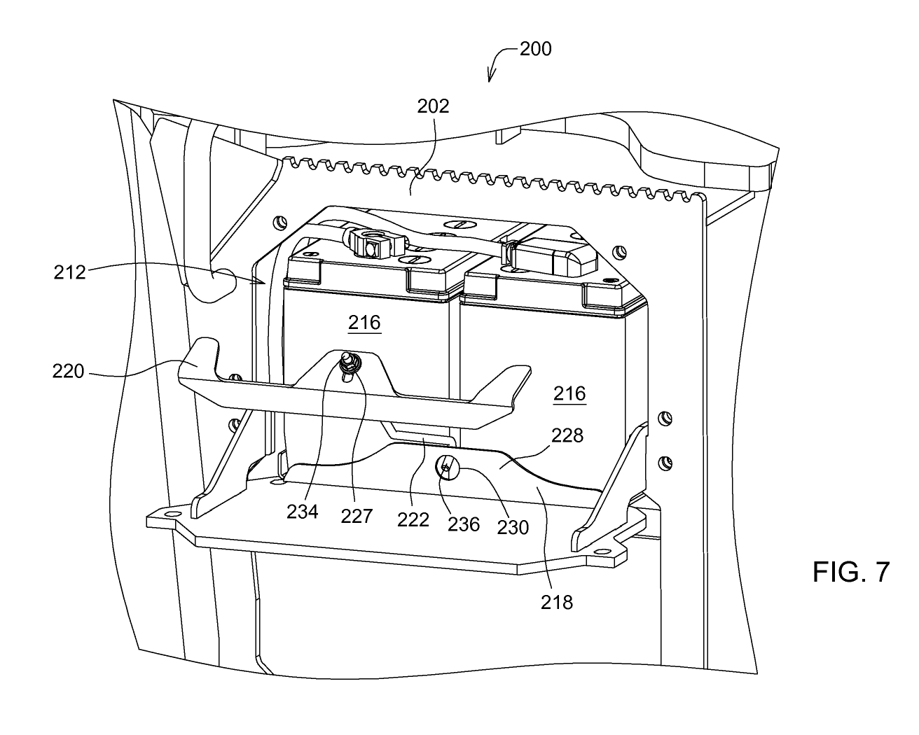

FIG. 7 illustrates the example battery storage apparatus 200 of FIGS. 2-5. In FIG. 7, the retainer 220 has been loosened from the batteries 216 to prepare the batteries 216 to be moved to the service position. To loosen the retainer 220, the fastener 227 is loosened from the first end 234 of the rod 222. The second end 236 of the rod 222 is disengaged from the catch 238 in the base 214 of the battery housing 212 and engages the lip aperture 230 of the first lip portion 228 of the tray 218. The retainer 220 is configured to provide a handle for a user to pull the batteries 216, via the rod 222 and the tray 218, onto the first cover 204 in the service position.

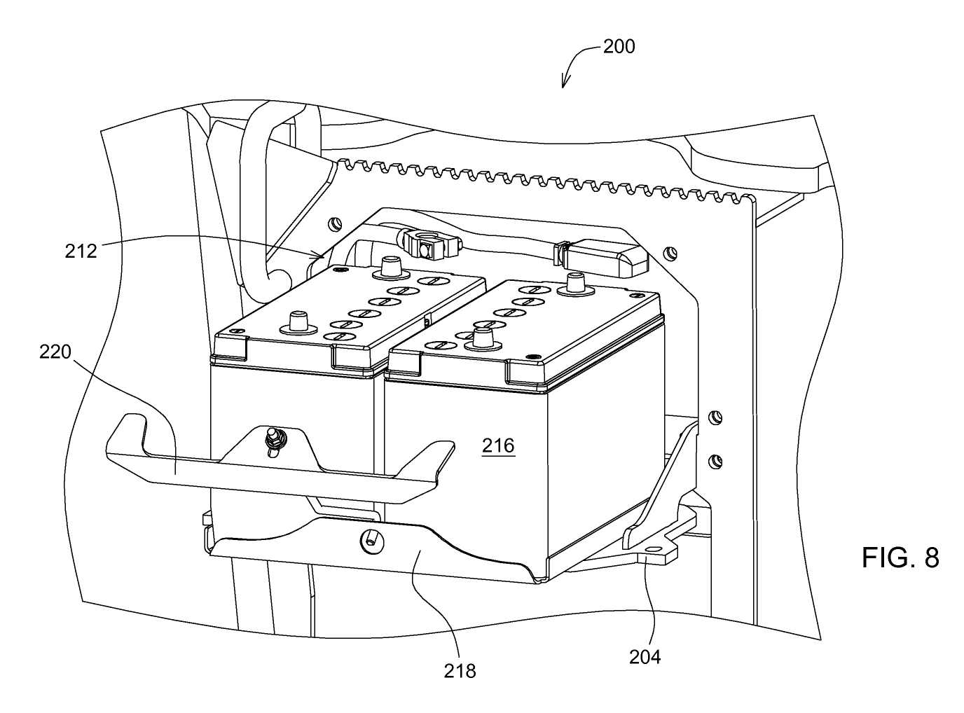

FIG. 8 illustrates the example battery storage apparatus 200 of FIGS. 2-5 and 7 with the batteries 216 disposed in the service position. As mentioned above, a user may pull the retainer 220 to slide the batteries 216, via the rod 222 and the tray 218, onto the first cover 204 in the service position. In certain examples, the battery housing 212 includes alignment features to facilitate slidable movement of the tray 218 to between the operable position and the service position. Upon being moved to the service position, the batteries 216 are easily accessible for maintenance and/or removal. For example, a user can easily grip the batteries 216 so that they may be removed without being encumbered by other components in close proximity to the batteries 216.

Although certain example methods, apparatus and articles of manufacture have been disclosed herein, the scope of coverage of this patent is not limited thereto. On the contrary, this patent covers all apparatuses, methods and articles of manufacture fairly falling within the scope of the appended claims either literally or under the doctrine of equivalents.

What is claimed is:

1. An apparatus, comprising:
a housing to store at least one battery of a working machine;
a cover removably attached to the housing, the cover being positionable between an operable position and a service position; and
a tray to hold the at least one battery, the tray disposed on a base of the housing, wherein the cover at least partially supports the tray in the service position.

2. The apparatus as defined in claim 1, wherein the housing is at least partially disposed within a step of the working machine.

3. The apparatus as defined in claim 1, wherein the cover defines a service platform to receive the at least one battery in the service position.

4. The apparatus as defined in claim 1, wherein the cover includes brackets to engage mounting features on the working machine to support the cover in the service position.

5. The apparatus as defined in claim 4, wherein the cover is to slidably receive the at least one battery, via the tray, in the service position.

6. The apparatus as defined in claim 5, wherein the tray includes lip members to retain the at least one battery on the tray.

7. The apparatus as defined in claim 5, further comprising a retainer and a rod, the rod having a first end and a second end, the first end adjustably coupled to the retainer, and the second end to engage a catch of the base of the housing via an aperture in the tray in the operable position to secure the at least one battery within the housing.

8. The apparatus as defined in claim 7, wherein the second end of the rod is configured to engage an aperture of a lip member of the tray to pull the at least one battery, via the tray, onto the cover in the service position.

9. The apparatus as defined in claim 8, wherein the retainer is configured to provide a handle for a user to pull the at least one battery, via the rod and the tray, onto the cover in the service position.

10. The apparatus as defined in claim 1, further comprising a bottom cover removably attached to the housing, the bottom cover being attached to the housing in the operable position and detached from the housing in the service position.

11. The apparatus as defined in claim 10, wherein the bottom cover includes a step.

12. An apparatus, comprising:
a battery housing of a working machine defining a cavity for storing at least one battery; and
a cover removably attached to the battery housing and configurable between an operable position and a service position, the cover including first and second brackets fixably attached to the cover and first and second hooks extending from each of the first and second brackets, the first and second hooks to engage respective mounting features of the battery housing to support the cover in the service position.

13. The apparatus as defined in claim 12, wherein the mounting features of the battery housing include mounting tabs, each of the mounting tabs having a top surface and an aperture.

14. The apparatus as defined in claim 13, wherein the first hook of each of the first and second brackets engages the top surface of the respective mounting tabs and the second hook of each of the first and second brackets engages the aperture of the respective mounting tabs to support the cover in the service position.

15. The apparatus as defined in claim 12, where the cover encloses the cavity of the battery housing in the operable position.

16. The apparatus as defined in claim 12, further comprising a tray disposed on a base of the cavity, wherein the at least one battery is slidable from the operable position to the service position via the tray.

17. The apparatus as defined in claim 16, further comprising a retainer to retain the at least one battery in the operable position.

18. The apparatus as defined in claim 17, further comprising a rod having a first end and a second end, the first end adjustably coupled to the retainer and the second end to engage a catch of a base of the housing via an aperture in the tray in the operable position to secure the at least one battery within the housing, and to engage an aperture of a lip member of the tray to pull the at least one battery, via the tray, onto the cover in the service position.

19. The apparatus as defined in claim 18, wherein the retainer is configured to provide a handle engageable by a user to slide the at least one battery, via the handle and the tray, from the operable position to the service position.

20. The apparatus as defined in claim 12, wherein the housing is at least partially disposed within a step of the working machine.
